(19) United States
(12) Patent Application Publication
(10) Pub. No.: US 2011/0240771 A1
(43) Pub. Date: Oct. 6, 2011

(54) PRESSURIZED FLUID SPRAY CONTAINER EXTENSION DEVICE

(76) Inventor: Peter Paul Legeza, Ponte Vedra Beach, FL (US)

(21) Appl. No.: 13/046,057

(22) Filed: Mar. 11, 2011

Related U.S. Application Data
(60) Provisional application No. 61/318,846, filed on Mar. 30, 2010.

(51) Int. Cl. B05B 15/08

(52) U.S. Cl. 239/588

(57) ABSTRACT

A pressurized fluid spray container extension device which has a trigger at the spray container to actuate a remote spray nozzle at the end of an extension tube to deliver a spray upon objects at a distance from the container.

### RELATED APPLICATION

This application is a non-provisional of U.S. Provisional Application Ser. No. 61/318,846, which was filed Mar. 30, 2010. Applicant hereby claims the benefit of that application, and the entire description and all claims of that application are incorporated herein by reference.

### FIELD OF THE INVENTION

This invention relates to pressurized fluid spray containers, and, more particularly, to an extension device for enhancing the use of the container to propel a liquid or powder product under pressure from the container onto an object at a location distant from the container.

### BACKGROUND OF THE INVENTION

Pressurized fluid spray containers such as aerosol cans, spray bottles, and the like have been widely employed to dispense various liquid or powdered products. The locations of objects to be treated with such products are not always easy to reach. For example, it is a common problem of trying to spray a liquid from an aerosol can onto an object located in a confined or difficult to reach space. It is conventional to use a tube or straw that is provided with many aerosol cans. Typically, the straw is wedged into a recessed portion of the aerosol actuator and allows for a more precise application of the liquid or powder in areas with a direct line of sight at relatively short distances from the spray can. A number of devices or assemblies have been proposed to address the problems associated with spraying objects which are far from the dispenser or are difficult to reach. Examples of conventional devices in the patent literature include EP 1088772 A2; GB 1144385A; U.S. Pat. No. 2,759,765; U.S. Pat. No. 2,968,441; U.S. Pat. No. 3,148,806; U.S. Pat. No. 4,350,299; U.S. Pat. No. 5,058,783; U.S. Pat. No. 5,307,964; U.S. Pat. No. 5,423,458; U.S. Application 2005/0051578; and U.S. Application 2009/0008479. However, in most cases, the problem of providing a consistent product spray with the devices that are available, and to maneuver the devices for the application of the spray, still remains problematic.

### SUMMARY OF THE INVENTION

The present invention relates to a pressurized fluid spray container extension device. The device enables spraying fluid products onto objects at a distance from the spray container effectively and with a consistent or uniform spray treatment. Fluid products such as aerosols, liquids or powders are pressurized in a container containing a propellant, such as a gas or volatile liquid, and dispensed as a spray. The device comprises an elongated fluid dispensing flexible tubing having an adapter at one end for detachable connection to the spray orifice of the valve operating spray nozzle of a pressurized fluid spray container. Typically, the container is an aerosol can housing fluid under pressure for dispensing various liquids and/or powders. The device adapter is positioned relative to the spray nozzle of the container and has a spray actuator or trigger which operates the valve operating spray nozzle of the container to dispense fluid under pressure from the container. The spray actuator is operated by hand, usually while holding the can in the same hand, in the case of a small can. A remote spray nozzle is connected to the opposite end of the flexible tubing. The remote spray nozzle has a pressure valve which is operable by the pressurized fluid between an open position and a closed position. In the closed position, pressurized fluid is maintained in the flexible tubing between the valve operating spray nozzle of the container and the remote spray nozzle of the tubular extension. The remote spray nozzle pressure valve is operable by actuating the spray actuator at the container to dispense the fluid.

In a preferred form, the flexible tubing of the device has an inner fluid dispensing tube and an outer tube which provides structural support for the inner tube. Preferably, the outer structural supporting tube is made of material that can be manipulated into a relatively permanent configuration which assists in placing the flexible tubing along a path, even a tortuous path, to reach an object for spraying. An example of a preferred arrangement of the extension device includes a plastic flexible inner tube and an outer stiffer plastic structural tubing surrounding the inner plastic tube. The stiffer outer tube can have segments, or is coiled, and capable of being manipulated into various stable configurations to facilitate reaching the object to be sprayed. The invention and its various embodiments will be further understood with reference to the attached Drawings and Detailed Description.

### BRIEF DESCRIPTION OF THE DRAWINGS

A detailed description of the preferred embodiments of the invention follows, with reference to the attached drawings, wherein:

FIG. 1 is a cross-sectional side view of the extension device of this invention.

FIG. 2 is an enlarged cross-sectional view of the remote spray nozzle and valve of FIG. 1.

FIG. 3 is an cross-sectional view of another remote spray nozzle and valve suitable for use in this invention.

FIGS. 4 and 5 are elevational views of the extension device with the adapter for connection to a conventional spray can top.

FIG. 6 is an exploded enlarged view of the remote spray nozzle assembly of FIG. 1.

FIG. 7 is an enlarged view of the spring and ball arrangement of FIG. 6, showing the relationship of the parts.

FIG. 8 is a further illustration of the inner flexible tube and outer structural tube surrounding the inner tube, illustrating a preferred embodiment of the extension device.

FIG. 9 is a dimensional view in perspective of the device secured to an aerosol can.

FIG. 10 illustrates the extension device detachably secured over the spray orifice of the container.

FIG. 11 illustrates the outer housing of a cap design.

### DETAILED DESCRIPTION OF THE INVENTION

The pressurized fluid spray container extension device can be attached to a conventional liquid or powder aerosol can to provide a spray extender for delivering a product at a distant or difficult to reach location.

The following is a numerical index of the structural components of a preferred device for referencing to the drawings.

21. Remote spray nozzle

22. Remote spray orifice

23. Spring for one way remote valve

24. Ball for one way remote valve

25. Ball and spring valve housing

26. Outer supporting tube

27. Inner pressurized fluid tube

28. End of pressurized fluid tube capped or bored into a cylindrical shape, which acts as the cup for the ball and spring valve

29. Flex section of outer supporting tube

30. Lip on spray cap that allows for connection to the outer tube of device.

31. Female section of spray cap where inner propellant tube connects

32. Trigger used to spray the device by putting downward pressure onto the valve stem of the aerosol can

33. Aerosol can

34. Main housing for sprayer to aerosol can base

35. Lip that allows for connection of the base to the aerosol can

36. Hollow male adapter for connecting inner pressurized fluid tube to sprayer base

37. Female connection for aerosol can stem valve

38. Empty section of cap to allow sprayer hose to pass through

39. Outer housing for possible cap design.

40. Can stem valve

41. Device holder on can

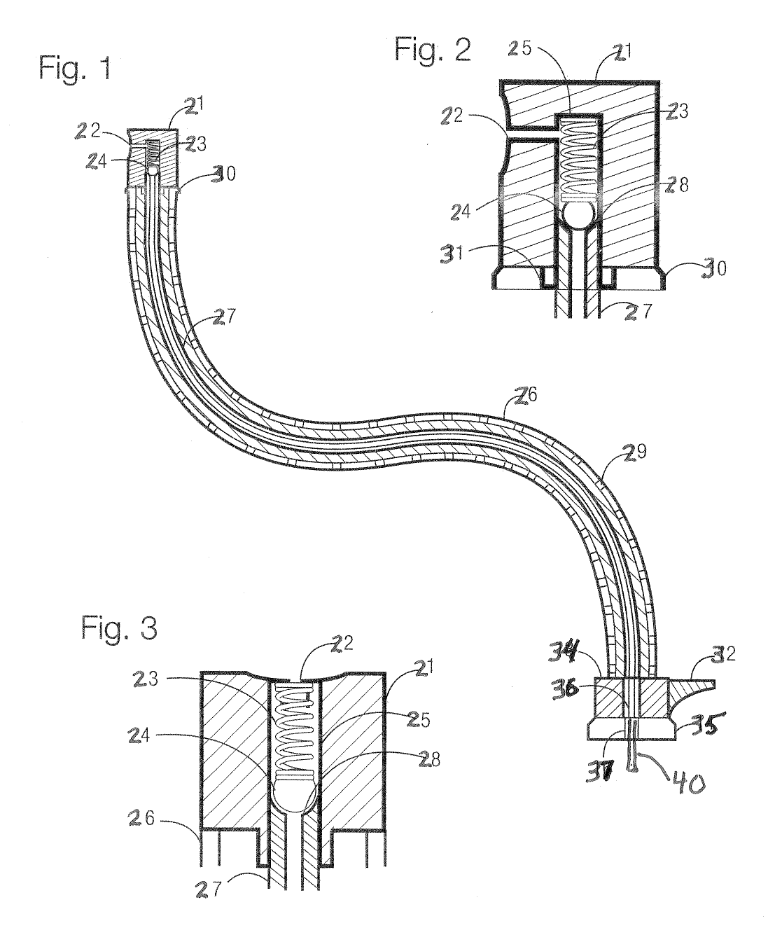

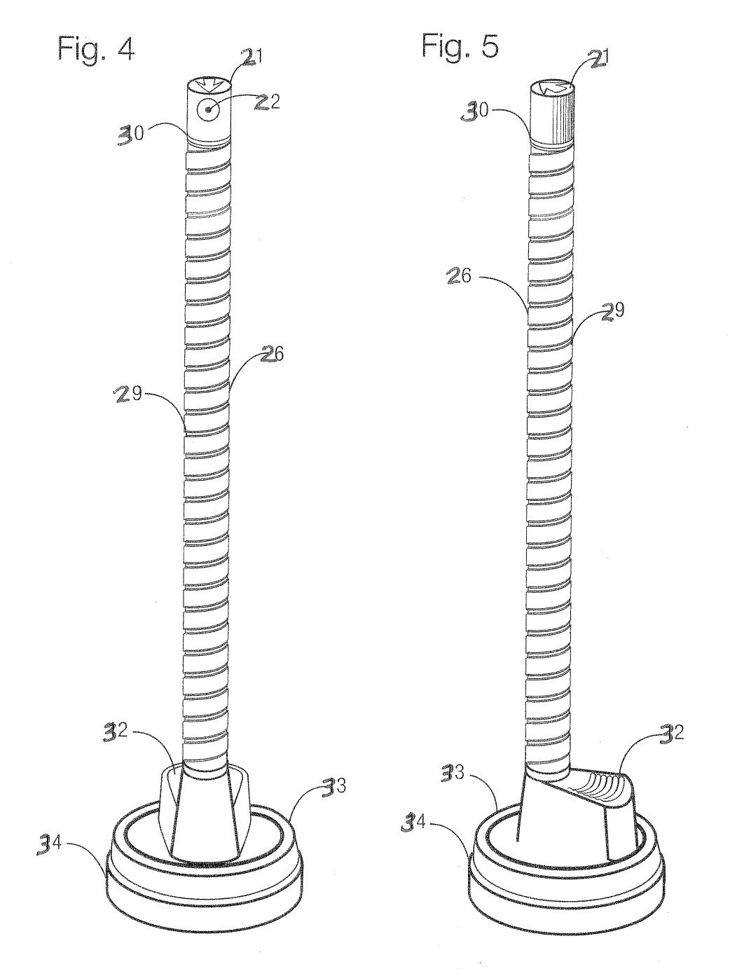

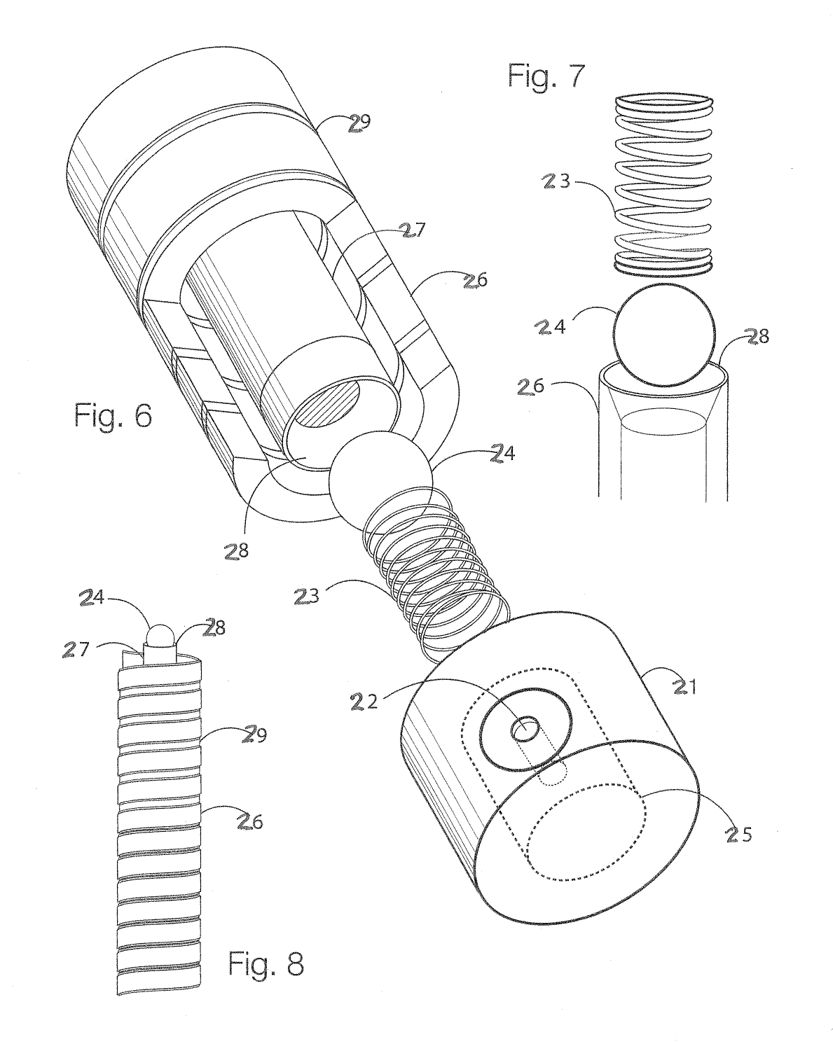

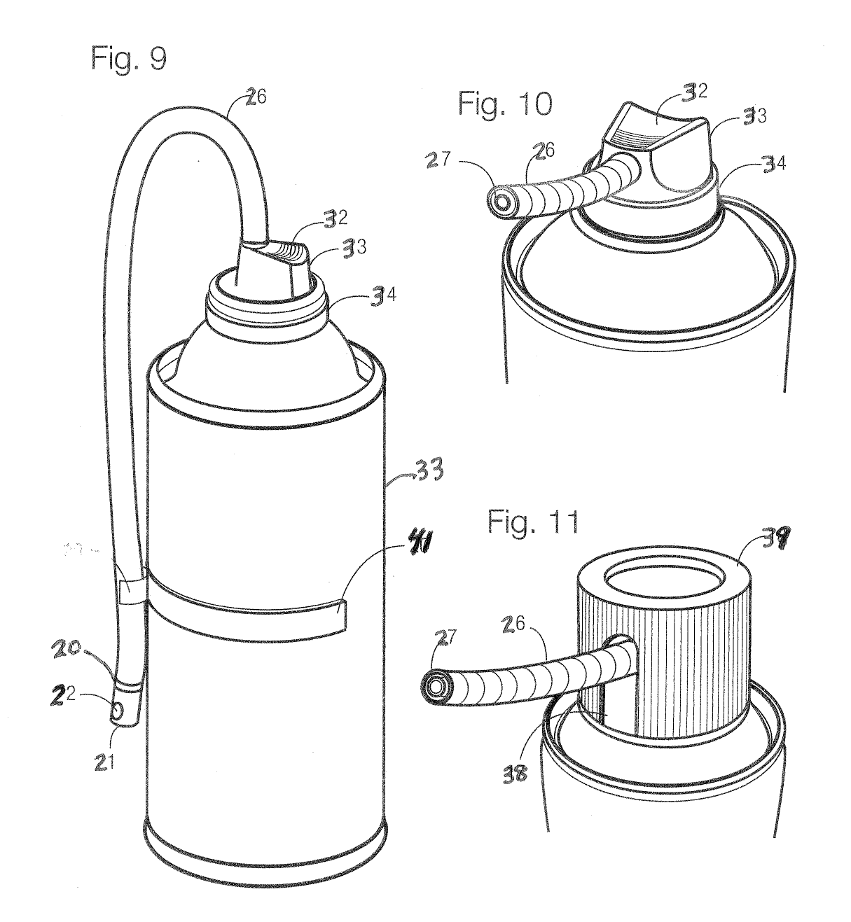

With reference to the drawings and the numerical index, the structure and operation of the various components of the pressurized fluid spray container extension device, as well as the preferred form of the invention, may be understood. The extension device is comprised of an elongated flexible tubing having an outer supporting tube coil 26 and an inner pressurized fluid tube 27 for the product being dispensed under pressure with reference to FIGS. 1-5. A flex section 29 of the outer tube 26 is shown in FIG. 1. FIGS. 1-3 illustrate the remote spray nozzle 21, one-way valve 22, spring for one-way valve 23, and ball 24 for one-way valve, and ball and spring valve housing 25. The lip 10 on the spray cap allows for connection to the outer tube 26. The outer tube 26 has an adapter 36 at one end for connecting the inner tube 27 via lip 35 to the sprayer base as shown in FIG. 1. As also shown, female connection 31 enables the aerosol can stem valve 20 to be inserted into the hollow male adapter 35 for connecting the inner tube 27 to the sprayer base. The adapter 36 has a trigger 32 or spray actuator which is used to spray the pressurized fluid device by putting downward pressure onto the valve stem 20 of the aerosol can 33.

The remote spray nozzle 21 and spray orifice 22 with valve spring 23 and valve ball 24 in housing 25 is shown with reference to FIGS. 1-3. The remote spray nozzle 21 is connected to an opposite end of the flexible tubing 26, 27. The remote spray nozzle 21 has a remote pressure valve assembly with operable components 22-25, which are operable between an open position and a closed position to maintain, in the closed position, pressurized fluid in the inner tubing 27 between the valve stem 40 operating spray nozzle of the can 33 and the remote spray nozzle 21 of the device. The spray actuator or trigger 32 is operable to actuate the remote pressure valve assembly 22-25 to dispense fluid from the container. This is achieved by the fluid pressure being released from the can to actuate the open position on the remote pressure valve assembly 22-25 of nozzle 21.

In operation, the extension device of this invention solves existing problems in current devices. The flexible fluid-carrying tube has a bendable shape-holding outer tube which facilitates placement of the spray into places that are hard to reach. The one-way spring and ball valve, housed at the end of the elongated tube, allows the entire dispensing tube to be pressurized before the fluid is sprayed from the device. The device also allows for the bendable shape-holding extension to be snaked into tight and hard to reach places for spraying a consistent propellant and product mixture onto an object. The device is suitable for many applications, such as spraying difficult to access machine parts with lubricant or even to coat one's own back with an alcohol-based aerosol sunscreen, for example.

In operation, the user need only depress the trigger of the adapter at the can, for example, to reach distant objects with the remote nozzle of the extension device. The device is easily snapped on to a conventional lip of the aerosol can, and may be taken on and off easily, just like a regular aerosol spray tip. It can be detached and used on different cans. Moreover, the device uses the pressure of the can to open the remote valve, and achieve a uniformly distributed spray of liquid or powder into difficult or confined spaces.

What is claimed is:

1. A pressurized fluid spray container extension device comprising
an elongated flexible tubing for dispensing pressurized fluid from a container onto a remote object, said tubing having an adapter at one end for connection to the spray orifice of a valve operating spray nozzle of the container, said adapter having a spray actuator for the container nozzle to dispense fluid under pressure from the container,
a remote spray nozzle connected to the opposite end of the flexible tubing, said remote spray nozzle having a pressure valve operable by the pressurized fluid between an open position and a closed position, said closed position maintaining pressurized fluid in the tubing between said valve operating spray nozzle of the container and the remote spray nozzle,
said remote spray nozzle pressure valve operable by actuating the spray actuator of the container to dispense the fluid.

2. The device of claim 1 wherein the flexible tubing has an inner tube for the pressurized fluid and an outer structural tube supporting the inner tube.

3. The device of claim 2 wherein outer structural tube is manipulatable into various configurations to assist in locating the remote spray nozzle near the remote object being sprayed.

4. The device of claim 1 wherein said device adapter is detachable from the container.

5. The device of claim 1 wherein said fluid comprises a liquid.

6. The device of claim 1 wherein said fluid is an aerosol.

7. The device of claim 1 wherein said fluid contains a powder.
